(19) United States
(12) Patent Application Publication
(10) Pub. No.: US 2003/0115293 A1
(43) Pub. Date: Jun. 19, 2003

(54) Content delivery system and method

(76) Inventors: Brian Jeffrey Fogg, Stanford, CA (US); Mark Anthony McCabe, San Mateo, CA (US); Elissa Lee, Austin, TX (US); Christopher O. Scales, London (GB)

Correspondence Address: Theodore P. Lopez, MacPHERSON KWOK CHEN & HEID LLP, 2402 Michelson Drive, Suite 210, Irvine, CA, 92612, US

(21) Appl. No.: 10/289,853

(22) Filed: Nov. 6, 2002

Related U.S. Application Data
(60) Provisional application No. 60/338,595, filed on Nov. 6, 2001.

(51) Int. Cl. G06F 15/16

(52) U.S. Cl. 709/219

(57) ABSTRACT

A multimedia content delivery system for consumers who have acquired a product or article by chance or intent, which provides access to a digital experience. The digital experience can include static, interactive and continuously updated multimedia content, digital transactions and similar digital content. The consumer can mount the article on an interface device, which creates a link between the article and the digital experience. The digital experience can be accessed locally or downloaded from the Internet and, thereafter, displayed or played back to the consumer.

This application claims the benefit and priority of Provisional Application Serial No. 60/338,595, filed Nov. 6, 2001, which is herein incorporated by reference in its entirety for all purposes.

### BACKGROUND

1. Field of the Invention

The present invention relates to a content delivery system, and in particular, the invention relates to a content delivery system for providing access to multimedia content and digital transactions.

2. Related Art

Many product promoters and advertisers now realize that the popularity of personal computers and other personal processors, such as personal data assistants (PDAs), hand-held wireless devices and the like, has created entirely new avenues for product advertisement, product promotion and digital transaction. In addition, advent of the Internet and the World Wide Web (WWW) has created a new vehicle by which to provide multimedia content to consumers to inform, educate, transact with, and entertain the consumer.

Various processors, typically including a user interface and input/output devices, are used to access content stored locally on CD-ROM or remotely on the Internet. The consumer uses the processor to find promotional multimedia content. Typically, the consumer is provided a Uniform Resource Locator (URL) that addresses the location of the multimedia content.

In many instances, however, with regard to products, consumers may not be aware of the vast amount of multimedia content or the various types of digital transactions that may be available to them. Moreover, because of the vast amount of content available to consumers from various sources it becomes difficult to focus the consumer's attention on a single product or line of products. Further, many consumers, especially children, may find that using processors and URLs difficult or inconvenient.

### SUMMARY

The present invention provides a system and method for offering a multimedia content delivery use for consumers. The multimedia content delivery can provide access to a digital experience. The digital experience can include access to various forms of multimedia content, digital transactions and other such digital content. The digital experience can enhance the attractiveness of a product to promote use of the product, interest in the product, interest in subject matter associated with the product, and sales of the product and associated products.

In accordance with the present invention, the product can be, or can be provided with, an element linking the consumer to the digital experience. Advantageously, consumers who do not presently have the product can be motivated to acquire it, which can have a pronounced effect on sales promotion of the product or the sales promotion of associated products.

In some embodiments, the product may include recorded information for addressing the digital experience. The recorded information makes the digital experience available to the consumer as the product is operably coupled directly or through use of a relay to a content providing terminal. The recorded information provides access through the terminal to the digital experience either at a local locale (via CD-ROM or DVD) or provided through a network, such as the Internet. The digital experience can then be displayed or played back to the consumer. The consumer can then interact with the digital experience, if appropriate, to perform actions, such as conduct a digital transaction, conduct research, participate in a game or perform similar interactive events.

In one aspect of the invention, the system and method of the present invention allows for accessing the digital experience using a physical object, called a key. The key can be a part of the consumer product or may be a separate object. The key can provide both an input and output capability, and can be used either alone or in combination with other keys. Advantageously, the key can be made to store historical information related to consumer behavior and usage patterns. For example, the key can be made to store historical information regarding, which multimedia content the consumer has already accessed to prevent a consumer from reviewing the same content during subsequent uses of the same key.

Advantageously, new information can be downloaded and stored to the key. During subsequent uses of the key, the new information can lead to new digital experiences, or to the restricting or focusing of the digital experience. The new information can be passed to other consumers by passing on the key.

In most aspects of the present invention, the key can be made to match the digital experience it cues. For example, if the key takes the form of a soccer ball, the key can cue up a digital experience related to various soccer materials, such as professional team rosters, instructional aids on the game of soccer and an interactive digital soccer match (i.e., video game).

The system also includes a cradle unit, which may be operably coupled to a processor, such as a PC, a television, a PDA and the like. The cradle unit is capable of receiving the key and reading identification information therefrom. The identification information is used as a factor in determining which digital experience should be displayed or broadcast to the consumer. Advantageously, the cradle unit may also be used as an output device, including an LED readout or audio speaker. In some instances, the cradle unit may take the form of a PC peripheral, stand alone appliance, a TV, a stereo and the like.

In one aspect of the invention, the processor may execute a software program. The software program can receive the identification information from the cradle unit. The software program can use the identification information to provide the digital experience to the consumer associated with the identification information. Optionally, after receiving the identification information, the software program can relay the identification information to an alternate computer device (e.g., a server), which is used to determine, which digital experience is associated with the identification information. The alternate computer device can then transmit the digital experience to the processor to be displayed, broadcast or both to the consumer.

For purposes of summarizing the invention, certain aspects, advantages, and other features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 is a simplified illustration of a system concept of one embodiment in accordance with the present invention;

FIGS. 2a and 2b are simplified illustrations of system configurations in accordance with embodiments of the present invention;

FIGS. 3a and 3b are simplified illustrations of an embodiment of a product and an interface device in accordance with an embodiment of the present invention;

FIGS. 3c-3g are illustrations of various embodiments of the interface between the product and interface device of FIGS. 3a and 3b;

FIG. 4 is a simplified system diagram incorporating the interface device of FIGS. 3a and 3b;

FIG. 5 is a simplified illustration of a memory map of a memory device of an Internet terminal in accordance with an embodiment of the present invention;

FIG. 6 is a simplified system diagram of a content-providing server and a database in accordance with an embodiment of the present invention;

FIGS. 7a and 7b are simplified illustrations of a record structure of a user database and a content database in accordance with an embodiment of the present invention;

FIG. 8 is a flowchart of an initialization process for the Internet terminal in accordance with an embodiment of the present invention;

FIGS. 9, 10, and 11 are flowcharts illustrating operations of a content provider service in accordance with an embodiment of the present invention;

FIG. 12 is a simplified illustration of correspondence between a content file in a content database and information intrinsic to a product as in FIGS. 3a and 3b;

FIGS. 13a and 13b are flowcharts illustrating improved flexibility of the content provider service; and

FIG. 14 is a simplified illustration of an embodiment of the content provider system including mobile phones in accordance with an embodiment of the present invention.

Uses, advantages, and variations of the present invention will be apparent to one of ordinary skill in the art upon reading this disclosure and accompanying drawings.

### DETAILED DESCRIPTION

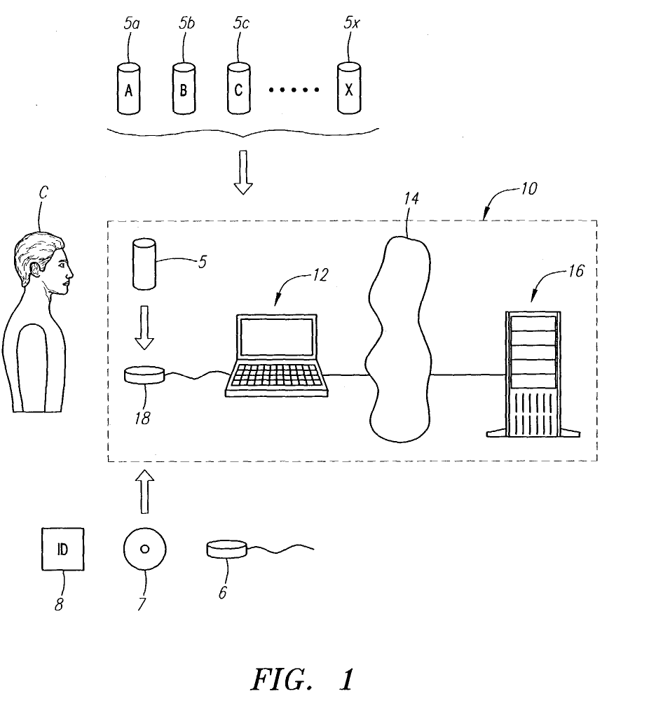

FIG. 1 is an illustration of an environment for operating a multimedia content delivery system 10 in accordance with an embodiment of the present invention. System 10 includes a processor 12, which can be coupled to a network 14, a content provider 16, and an interface device 18. It should be understood that processor 12 and content provider 16 can be the same or different processor. In addition, the functionality provided by processor 12 or content provider 16 may be implemented as one or more program modules that execute on one or more processors.

Processor 12 and content provider 16 can be any processor or microprocessor controlled device. For example, a personal computer (PC), servers, mini-computers, mainframes, laptop computers, handheld computers, palm top computers, PDAs, television or stereo set top boxes, wireless devices and the like or any combination thereof. The processors can execute an appropriate operating system such as Linux, Unix, Microsoft® Windows® 95, Microsoft® Windows® 98, Microsoft® Windows® NT, Apple® MacOS®, IBM® OS/2®, and the like. The processors may advantageously be equipped with a network communication device such as a network interface card, a modem, or other network connection device suitable for connecting to one or more networks.

Processor 12, and the processor memory, may advantageously contain program logic or other substrate configuration representing data and instructions, which cause the processors to operate in a specific and predefined manner as, described herein. The program logic may advantageously be implemented as one or more modules. The modules may advantageously be configured to reside on the processor memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like.

The program logic conventionally includes the manipulation of data bits by the processor and the maintenance of these bits within data structures resident in one or more of the memory storage devices. Such data structures impose a physical organization upon the collection of data bits stored within computer memory and represent specific electrical or magnetic elements. These symbolic representations are the means used by those of ordinary skill in the art to effectively convey teachings and discoveries to others of ordinary skill in the art.

The program logic is generally considered to be a sequence of processor-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those of ordinary skill in the art to refer to these signals as bits, values, elements, symbols, characters, text, terms, numbers, records, files, or the like. It should be kept in mind, however, that these and some other terms should be associated with appropriate physical quantities for processor operations, and that these terms are merely conventional labels applied to physical quantities that exist within and during operation of the processor.

It should be understood that manipulations within the processor are often referred to in terms of adding, outputting, receiving, accessing, comparing, retrieving, playing, moving, searching, or the like, which are often associated with manual operations performed by a human operator. It is to be understood that no involvement of the human operator may be necessary, or even desirable. The operations described herein are machine operations performed in conjunction with the human operator or user that interacts with the processors.

It should also be understood that the programs, modules, processes, methods, and the like, described herein are but an exemplary implementation and are not related, or limited, to any particular computer, apparatus, or computer language. Rather, various types of general purpose computing machines or devices may be used with programs constructed in accordance with the teachings described herein. Similarly, it may prove advantageous to construct a specialized apparatus to perform the method steps described herein by way of dedicated computer systems with hard-wired logic or programs stored in non-volatile memory, such as read-only memory (ROM).

Referring again to FIG. 1 a consumer C (also referred to as a “user”) is provided access to processor 12. In one embodiment, processor 12 is a PC 12, with no intent to limit the invention thereby. Personal computer 12 includes a monitor for displaying, a keyboard for entering text data and user commands, and a pointing device for processing objects displayed on the monitor. Computer 12 can also access a computer-readable floppy disk storing data files, application program files, and software including computer executable process steps or the like via a floppy disk drive. A CD-ROM and/or DVD interface may also be provided with computer 12 to access application program files, audio files and data files stored on a CD-ROM or DVD.

Computer 12 can also include a modem, an integrated services digital network (ISDN) connection, and the like to allow for an Internet connection. The Internet connection allows PC 12 to download data files, audio files, application program files and computer-executable process steps and the like. Computer 12 can include a computer-readable memory medium such as a rotating disk for storing readable data. In addition to other programs, the disk can store application programs including web browsers by which PC 12 connects to the supported wide area network (WAN, hereinafter referred to as the “Internet”).

In some embodiments, computer 12 includes a CPU for executing computer-executable process steps and interfaces. As described above, the disk stores operating system program files, application program files, web browsers, and other files. A random access main memory (“RAM”) provides CPU with access to memory storage. Read only memory (“ROM”) is provided to store invariant instruction sequences such as start-up instruction sequences or basic input/output operating system (BIOS) sequences.

Computer 12 has functions that enable access to many and various servers and computers on Internet 14. For example, servers can include the WWW, providing web documents in hypertext markup language format, and servers that allow the downloading of electronic documents by file transfer protocol (FTP), and the like. The user need only subscribe to an Internet Service Provider (ISP) in order to freely access Web servers, FTP servers, and the like, on Internet 14.

In one embodiment, content provider 16 can be a content-providing server configured to perform functions, such as user authentication, association of the digital experience with consumer provided identification information, retrieval and delivery of the digital experience and multimedia content delivery history management. In some embodiments, content provider 16 references information regarding the consumer's usage and other information each time content is provided. Content provider 16 conducts processes that can avoid multiple delivery of the same content and enables optimal content selection from undelivered content (e.g., optimal content selection that includes continuity with the closest delivered content).

In one embodiment, the multimedia content delivery can provide access to the digital experience, which can include access to various forms of multimedia content, digital transactions and other such digital content. For example, multimedia content can include video data, audio data, Real Video data for on-demand distribution and the like, which provides the digital experience to the user. In another example, digital transactions can include various levels of interaction with the various forms of multimedia content to create and provide an interactive digital experience to the user. Accordingly, the digital experience can be interactive, static and continuously updated. The digital experience can be transmitted to the monitor of PC 12 and displayed, while content provider 16 maintains a record of delivered content for each user.

Referring again to FIG. 1, interface device or key interface 18, such as a cradle or similar device (hereinafter “cradle 18” or “cradle unit 18”) can be operably coupled to computer 12 using a standard connection. Cradle 18 is equivalent to the terms “relay means” and “connection means” as used herein with the present invention. In one embodiment, cradle 18 can be used as an input device, upon which keys are positioned for operation in accordance with the present invention. Cradle 18 can also function as an output device, which includes an LED readout display, an audio speaker, and the like for communicating information to consumer C.

In some embodiments, cradle 18 can take the form of a PC peripheral, such as a mouse, or a pointing device. Cradle 18 can be a standalone device, such as a set top box for a television or a stereo receiver. In one embodiment cradle 18 may be combined with a printer to include a printing function. In still another embodiment, cradle 18 can be configured with the appropriate logic to provide input and feedback control. In one embodiment, cradle 18 may include controls for the delivery of the digital experience, such as a volume control and stop and play function controls and navigational controls, such as Back/Forward/Home controls similar to those developed for Internet browsers. Optionally, cradle 18 may include a “joystick” or similar mechanism to allow cradle 18 to be used as a device with which to enable the user to interact with the digital experience.

In one example, illustrated in FIG. 1, consumer C mounts an article 5 (equivalent to “key,” “commodity,” “model,” “product,” “collectible” and the like) on cradle 18. It is expected that the shape of article 5 is a design suitable to attract the interest of consumer C. For example, article 5 may be a model of a popular animation character or other sought after popular item. Article 5 can be either a product sold separately or made available as a giveaway article with another product. Article 5 may also be a part of a collection of articles.

The digital experience made accessible by article 5 can correspond to or can be associated with article 5. In one embodiment, article 5 is a key for providing access to the digital experience. In addition, article 5 includes the ability to receive, store, and relay digital information or data.

Article 5 (hereinafter “key 5”) can be any physical object, such as toys, collectibles, figurines, products, artifacts, parts of products, or other similar physical objects of various sizes and shapes. Key 5 is not limited to being an object or product for sale by a provider or manufacturer, but instead can be an object associated with a provider or manufacturer of objects. Key 5 can be a promotional product attached to or otherwise associated with a product or may be the product. The physical appearance of key 5 can be associated with the digital experience for which the key cues or otherwise provides access. For example, key 5 may be made in the appearance of a logo of a well-known restaurant. In this example, key 5 provides identification information to content provider 16, which relays the associated digital experience back to the consumer, including, a list of menu items, restaurant locations and operating hours. The digital experience may also provide the downloading to key 5 of a virtual food coupon to be used for food purchases at the restaurant.

As illustrated in FIG. 1, key 5 can be any object, such as objects 5a through 5x bearing shape types from Type A through Type X, which consumer C has acquired as products already on the market, either by intent (when sold as a product) or by chance (when presented as a giveaway accessory of a product).

In one embodiment, consumer C acquires key 5 of a certain shape (e.g., product 5a). For example, product 5a can be made in the shape of the Eiffel Tower and can include identification information that provides access to multimedia content relating to French history, French cuisine or to tourist information regarding France. The type information is recorded, for instance, by writing to a built-in electrical recording or semiconductor memory device embedded within key 5. In an alternative embodiment, the type information may also be recorded using a mechanical (physical) device in the mounting surface of product 5a, which interfaces with the mounting surface of cradle 18. In operation, cradle 18 reads, either mechanically or electrically, the type information recorded in product 5a, and transfers this information to computer 12.

In one embodiment, key 5 can include a read/write memory device, which enables the key to store data regarding skills, abilities, points and various forms of knowledge. For example, key 5 may also store points or currency of many forms. The value of the points or currency can increase or decrease over time as the consumer continues to view and interact with the digital experience for which key 5 provides access. In one embodiment, the currency can be used, for example, at retail outlets or at on-line retail websites, which can read the currency or point values stored on key 5.

The currency values stored on key 5 may also be used to pay for digital tickets, and in addition, store the digital ticket for redemption at a specific venue. For example, a key provides access to a digital experience related to movies recently produced by a specific production company. For accessing the multimedia content, the consumer is rewarded with “currency” for purchasing tickets to a movie of the consumer's choice. The consumer accesses the proper web page and redeems the currency for digital movie tickets that are stored on the consumer's key. The consumer takes the key to the movie venue where it is read to verify that the tickets have been purchased, which allows the consumer entry to the venue.

Through use of the read/write memory device, in addition to points or tickets, content can be added to key 5 by the consumer, such as pictures, stories, songs and the like. The consumer may be able to pass key 5 on to another consumer, so that the other consumer can enjoy the new content, use the points, redeem the stored tickets and perform other similar events.

Key 5 can be configured to interact with other keys. For example, a primary key can be used which designates a main topic, or main object. A secondary key when used in conjunction with the primary key, may unlock other content related to the main topic. In one embodiment, the primary key corresponding to the main topic can be made to store information made available through use of the secondary key, so that subsequent uses of the primary main topic key will not require the use of the secondary key.

Interaction between two or more keys may result in special access to content unavailable to only one key. The combination or use sequence can be made to yield different outcomes. In one example, a first key may provide access to a digital experience related to a particularly popular rock group. Access provided by the first key may lead to a multimedia experience that includes concert related information. The use of a second key alone, may provide access to the rock groups recorded musical performances. However, the use of the first key in conjunction with the second key may provide access to a live, on-line performance.

In one embodiment, when consumer C has acquired key 5 for the first time, in accordance with an attached instruction of key 5, consumer C conducts a procedure for acquiring cradle 18 and an application CD-ROM 7 (one type of recording medium). In this embodiment, the procedure can include user registration; which can require, in one instance, that the consumer C fill in the required items on a user registration form attached to the instruction manual and mail the form. Alternatively, the user may use computer 12 to start the Web browser software, access the address in the instruction manual and receive an electronic user registration entry page in which to fill in the required registration items. Required items of registration may include, for example, the name, address, age, and gender of consumer C.

Content providing system 10 can be notified as to the details associated with the registration of consumer C. On receiving the registration information for consumer C in the mail, the details of the information are entered into a user database. Alternatively, content provider 16 (or another similar server) used for disclosing the aforementioned user registration entry form page can be operated on Internet 14 to direct the required registration items into the user database.

On completing user registration, an ID card 8 incorporating user ID (and password), cradle 18, and CD-ROM 7 are made available to consumer C. On receiving ID card 8, cradle 18, and CD-ROM 7, consumer C loads CD-ROM 7 into computer 12, installs an application, program stored on the CD-ROM 7, and enters the user ID and password provided on ID card 8. The user ID and password are stored as authentication information to enable two-way access of computer 12 and content provider 16. Thereafter, consumer C can couple a communications device from cradle 18 to computer 12. Having mounted key 5 in the cradle 18, consumer C is able to access the digital experience from the content provider 16.

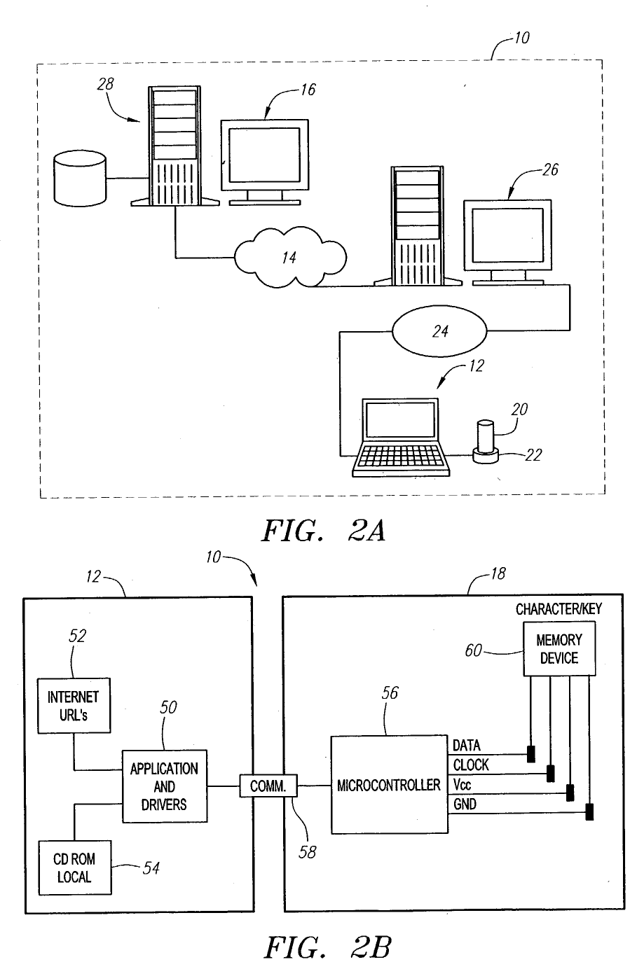

FIG. 2a illustrates an embodiment of content delivery system 10. In this embodiment, content delivery system 10 includes a key 20, a cradle 22, computer 12, a public telephone network 24, an access point server for an ISP 26, the Internet 14, a content delivery content provider 16, and a database 28. Although computer 12 is shown coupled to access point server 26 via the public telephone network 24, this does not limit the invention to one mode of Internet connection (dialup connection). Other modes, including dedicated lines or cable can also be used. Internet 14 may include one or a combination of networks, for example, a local area network (LAN), wide area networks (WAN), public internets, private intranets, a private network, a public network, interactive television networks, wireless data transmission networks, two-way cable networks, and other suitable data networks.

FIG. 2b is a block diagram illustrating an embodiment of content delivery system 10, indicating the relationship between host processor 12 and cradle 18 in accordance with an embodiment of the present invention. In this embodiment, an application program 50 controls communications between cradle 18 and computer 12, as well as between computer 12 and content provider 16. In one operational embodiment, computer 12, with the installed application program 50, is operably coupled to cradle 18. The computer 12 and cradle 18 are coupled together using any type of suitable hardware communications device 58, including by way of example, a Universal Serial Bus (USB), a well-known external bus standard, which supports peripheral devices, such as mice, modems, keyboards and “Plug-and-Play” installation and “hot plugging.”

Cradle 18 includes a microcontroller 56 that can detect the presence of, and can communicate with, memory device 60. Microcontroller 56 can be any suitable microcontroller device, including a USB microcontroller. Microcontroller 56 relays pre-programmed information from memory device 60 to computer 12, running application program 50.

In this operational embodiment, two exemplary applications can operate in accordance with the present invention. In the first exemplary application, application software 50 can include a list of pre-defined URLs. Upon notification from microcontroller 56 that key 5 has been made to engage cradle 18, application program 50 launches browser software and accesses a specific address, for example, from the list of Internet URLs 52. Next, authentication information (e.g., user ID and password) stored in computer 12 is sent to content provider 16 (FIG. 2a). Content provider 16 receives user authentication data. If the authentication result is approved, the internal information of memory device 60 is read and sent to content provider 16. The digital experience sent from content provider 16 in response to the approval, is downloaded to computer 12. Plug-in software can then be started in response to the content type. The content is displayed when the content is of the still image type, played back when the content type is a moving picture or of the audio type or interacted with as when the content is a game or requires input for any reason.

In the second exemplary application, application software 50 can include a list of local addresses. Upon notification from microcontroller 56 that key 5 has been made to engage cradle 18, application program 50 launches software modules located on the CD-ROM and accesses a specific address, for example, from the list of local addresses 54 of specific multimedia content stored on the CD-ROM. The identification of the local address is provided from the information made available on memory device 60 of key 5 to application software 50. In one embodiment, the CD-ROM is provided to the consumer along with cradle 18. The multimedia content addressed on the CD-ROM is downloaded to computer 12 or, alternatively, remains on the CD-ROM. Plug-in software can then be started in response to the content type. The content is displayed when the content is of the still image type, played back when the content type is a moving picture or of the audio type or interacted with as when the content is a game or requires input for any reason.

Further, the present invention is not limited to the above embodiments, but can encompass various other forms. For example, distribution of the application program for receiving the content delivery service need not employ a transportable recording medium, such as CD-ROM 7, but can also be distributed over Internet 14. In one embodiment, the application program may be downloaded from Internet 14 from an FTP server or HTTP (Hypertext Transfer Protocol) server.

Further, consumer C need not be the sole user. For example, a person other than consumer C, an individual whom consumer C has given permission, (e.g., a relative, friend and the like), either explicitly or implicitly, can use system 10 to access the content through computer 12.

The following is an account of embodiments of the present invention. With regard to the various details of this invention, any specified or actual example, or values, text, or other notation herein, is simply a reference for clarifying the concept of this invention, and it is clear that the concept of this invention is not, wholly or in part, limited to any of these embodiments. Furthermore, although detailed explanation of any commonly known method, procedure, architecture, circuit configuration, and the like (hereinafter, “commonly known items”) is avoided, this is also for the purpose of simplifying description, and in no way indicates intention to exclude, wholly or partially, those commonly known items. Because commonly known items are known by a person of ordinary skill in the art at the time of the filing of the present invention, those items may not be included in the following description.

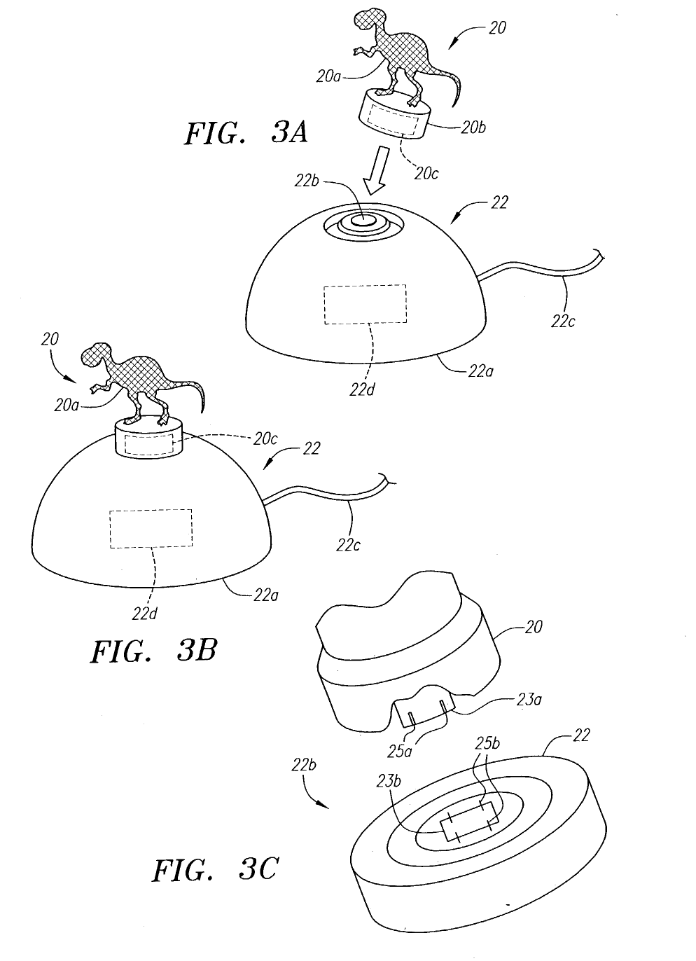

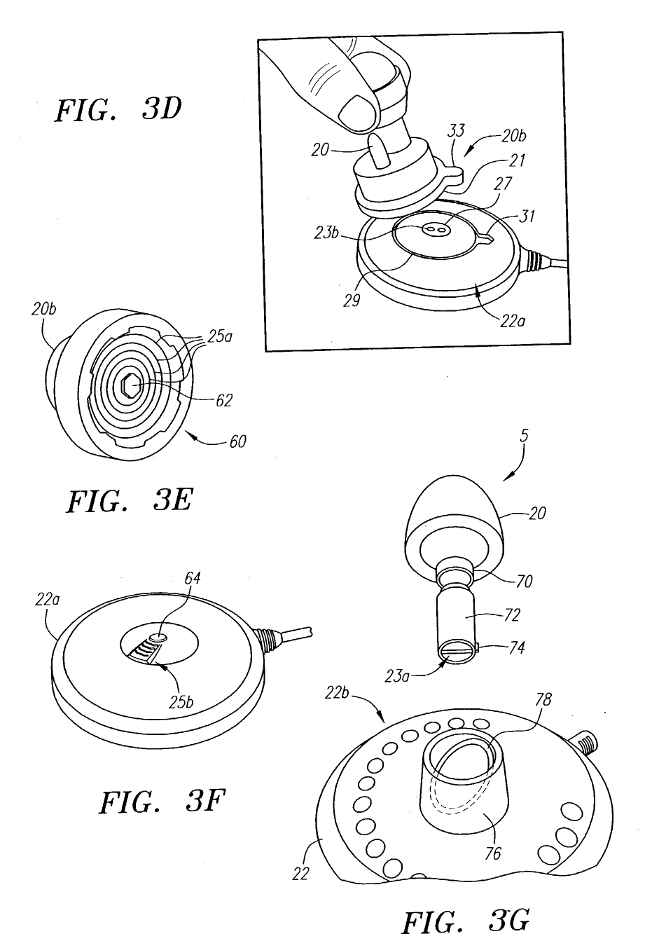

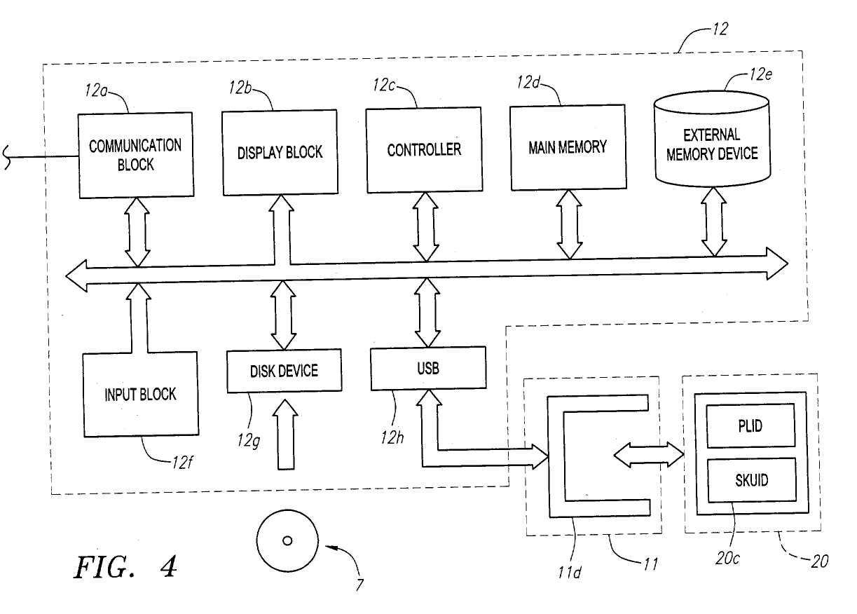

FIGS. 3a and 3b illustrates the appearance of a main unit or key 20 and cradle 22 in one embodiment. In this embodiment, main unit 20 is a suitably designed model, for example, a dinosaur statuette or model mounted on a stand 20b. The interior of main unit 20 (e.g., the interior of stand 20b) can include a semiconductor memory device 20c that stores information intrinsic to main unit 20 (hereinafter, “intrinsic information”). The semiconductor memory can be any well known type of semiconductor memory storage device or addressable storage medium well know to those of ordinary skill in the art, for example an random access memory (RAM), a static random access memory (SRAM), a dynamic random access memory (DRAM), a programmable read-only memory (PROM), an erasable programmable read-only memory (EPROM), an electronically erasable programmable read-only memory (EEPROM) and similar memory devices.

Stand 20b of main unit 20 is coupleable to an interface section 22b provided in the main structure 22a of cradle 22. When main unit 20 is mounted on cradle 22, computer 12 (not shown) reads the intrinsic information from memory 20c and transfers the information via cable 22c of cradle 22 to computer 12. Any universal standard computer interface for the transfer protocol, (i.e., the interface protocol between cradle 22 and computer 12) can be used for transferring the intrinsic information. For example, USB can be used which is supported by almost all contemporary computers, as the interface protocol between cradle 22 and computer 12, together with hot plug support (enabling cable plug-in/out with the power on). The following assumes, with no intent to limit thereby, that the interface between cradle 22 and computer 12 is a USB interface, and that cradle 22 is equipped with a USB internal interface microcontroller 22d.

FIG. 3c is a simplified illustration of one embodiment of interface section 22b. In this embodiment, interface section 22b includes well known card edge connector components, such as edge connector 23a and edge slot 23b. Edge connector 23a can have any number of electrical contacts, for example, four edge electrical contacts 25a, with two contacts arranged on either side of edge connector 23a. Edge slot 23b includes a corresponding number of slot electrical contacts 25b positioned to be aligned with edge electrical contacts 25a. In addition, slot electrical contacts 25b can be spring loaded contacts, which are compressed when edge connector 23a is inserted. In this manner, spring loaded contacts 25b maintain a force fit between both sets of contacts 25a and 25b to facilitate the flow of electrical current between the contacts.

Main structure 22a of cradle 22 is operable to receive stand 20b of main unit 20. In most embodiments, stand 20b can have a corresponding shape and size to interface section 22b. FIG. 3d is an embodiment of an interface between stand 20b and main structure 22a. In this embodiment, main structure 22a includes edge slot 23b, a first ring 27 and a second ring 29. Typically, to protect edge connector 23a (FIG. 3c), the edge connector is housed within stand 20b, not to extend beyond stand edge 21. To ensure that edge connector 23a can be properly mated into edge slot 23b, edge 21 can be insertable into second ring 29. This allows edge 21 to enter below the top surface of stand 20b, which allows edge connector 23a to be lowered into slot 23b.

Optionally, a configuration can be placed on either first ring 27 or second ring 29, which forces the consumer to place stand 20b onto cradle 22a in a specific orientation. For example, as shown in FIG. 3d, a nose 31 is placed on second ring 29 with a corresponding shaped region 33 on edge 21 of stand 20b. Nose 31 enables the consumer to locate card edge connector 23a with edge slot 23b to prevent the consumer from incorrectly seating edge connector 23a into edge slot 23b.

FIGS. 3e and 3f are yet another embodiment of stand 20b and interface section 22b in accordance with the present invention. In this embodiment, electrical contacts 25a are ringed shaped contacts disposed on a circular disc PCB 60. Interface section 22b includes corresponding, spring loaded contacts 25b, which are spaced concentrically to align with ring shaped electrical contacts 25a on PCB 60.

In this embodiment, a metal contact 62 is positioned on stand 20b, for example, in the center of electrical contact rings 25a. Metal contact 62 provides a surface upon which magnet 64 of main structure 22a can be joined. Upon joining metal contact 62 and magnet 64, electrical contact rings 25a on PCB 60 become aligned with electrical contacts 25b on main structure 22a. The strength of the magnetic contact pulls the PCB electrical contacts 25a onto the spring loaded electrical contacts 25b facilitating the flow of electrical current.

Advantageously, the magnetic connector embodiment of FIGS. 3e and 3f enable the consumer to couple stand 20b to main structure 22a without regard to the specific orientation of the electrical contacts relative to the PCB 60. For example, once stand 20b is located on interface section 22b, the consumer can turn main unit 20 around (on a vertical axis) without breaking the contact between contacts rings 25a and contacts 25b on cradle 22.

FIG. 3g is an illustration of yet another embodiment of the interface section 22b of the present invention. FIG. 3g includes an exploded view of a key 5, including main unit 20, a coupling ring 70, an edge connector housing 72, and edge connector 23a (coupled to memory device 60 within connector housing 72). Coupling ring 70 is coupled to an inner portion of any main unit 20. Coupling ring 70 provides a connection means for connecting connector housing 72 to main unit 20. All connections can be made in a conventional manner, such as by gluing, force fitting, or mechanically fastening onto coupling ring 70. At the base portion of connector housing 72 is a locator bump 74.

In this embodiment, interface portion 22b of main structure 22 can include a chimney shaped receptacle 76. Chimney shaped receptacle 76 provides access to a card edge connector slot, such as edge slot 23b (FIG. 3c) located at the bottom of chimney receptacle 76. A guiding device 78, such as cam 78 is located on the inner wall of chimney receptacle 76. Cam 78 can be designed such that contact between cam 78 and locator bump 74 causes connector housing 72 to move into a desired orientation when urged. For example, chimney receptacle 76 can be configured to receive connector housing 72 and bump portion 74, such that when main unit 20 is mounted onto chimney receptacle 76, locator bump 74 contacts cam 78. A downward force created by a consumer pushing main unit 20 onto cradle 22 causes connector housing 72 to twist, thus locating card edge connector 23a into card edge slot 23b.

In one exemplary embodiment, main unit 20 may be a promotional device which is to be used to promote the opening of a new retail outlet and e-commerce website. For example, the retail/e-tail outlet offers various videos, DVDs and music CDs for sale. In this embodiment, the consumer has purchased and installed cradle 22 from a retailer, including application software 50 provided on an accompanying CD-ROM. The retail outlet has also purchased and installed cradle 22. The consumer receives a main unit 20 via mail, which is a small key-ring sized article, made of molded plastic that resembles the retailer's logo. Once the consumer inserts main unit 20 into cradle 22, intrinsic information stored on the memory device 20c is relayed to computer 12 to launch an Internet browser application. The subscriber is exposed to a digital experience, which includes taking the subscriber to the retailer's web page, where the consumer can view the various consumer options.

In another embodiment, continuing with the above example, once the consumer reaches the retailer's web page, the consumer is offered special discounts for viewing additional content related to the retailer's c-commerce business. Once the consumer accesses the additional web pages, memory device 20c receives and stores “discount credits.” In addition, memory device 20c stores information downloaded from the web page, which instructs the retail outlet to discount the consumer's purchases. The consumer takes main unit 20 to the retail outlet. Main unit 20 is mounted onto the retailer's cradle 22. The consumer receives a discount for each video, DVD or CD purchased.

In another embodiment, continuing with the above example, the consumer is given a second main unit 20 for having made significant purchases. Second main unit 20 when used in conjunction with first main unit 20 provides the consumer even deeper discounts. As before, the “discount credits” are stored to memory device 20c of the second main unit 20. Because the consumer has purchased all of the music CDs he desires, the consumer gives the second main unit to his friend, who subsequently takes second main unit 20 to the retail outlet and redeems the discount credits.

In yet another exemplary embodiment, main unit 20 may be a promotional gadget or product accessory providing access to a new Internet service, for example, a music subscription service. Music subscription services typically allow downloading of music from the Internet in exchange for a monthly fee paid by the subscriber. In this embodiment, cradle 22 can be purchased from a retailer including a set of main units 20. Once the subscriber inserts main unit 20 into cradle 22, intrinsic information stored on the memory device 20c is relayed to computer 12 to launch an Internet browser application. The subscriber is exposed to a digital experience, which includes, taking the subscriber to a personal online music space, such as my mp3.com, where the subscriber's favorite songs can be accessed.

The web space acknowledges the presence of a particular main unit 20, by displaying an icon. Since a subscriber may use more than one main unit 20 to access the web space, each main unit can be represented by a different icon. In this example, using, for example, a “drag-and-drop” technique, the subscriber can allocate a playlist of songs to a particular main unit 20. In this embodiment, main unit 20 stores information in memory device 20c regarding the location of the playlist on content provider 16, or similar location, for later access. Memory device 20c also stores instructions related to the subsequent playing of the playlist.

To play music from a stored playlist, main unit 20 is re-mounted onto cradle 22. Since the application software can identify that main unit has already been used to identify a playlist, intrinsic information stored on memory device 20c activates music streaming software, for example, Real Player, which causes songs from the playlist to be streamed to the host PC and played back through speakers. Advantageously, main unit 20 can be used on any computer having cradle 22 attached thereto.

FIG. 4 is a simplified system diagram illustrating main unit 20, cradle 22, and computer 12. In the figure, computer 12 is shown equipped with a communications block 12a for Internet connection, a display block 12b for the user interface, a controller 12c (detection means, reading means, generation means, reception means, playback/output means, playback/display means) that controls all operations of the operating system and running of applications on computer 12. Computer 12 can also include main memory 12d that can become a work area for control purposes, an external memory device 12e that stores the operating system, applications and various data, an input block 12f for keyboard, pointing device, and the like, a transportable recording medium (in particular the previously mentioned CD-ROM 7) including a disc drive device for reading recorded data 12g, and a USB port 12h.

Cradle 22 can also be equipped with a USB interface 11d that conducts communications with USB port 12h of computer 12. When main unit 20 is mounted on cradle 22, intrinsic information is read from the semiconductor memory 20c of main unit 20, and transferred to computer 12 via USB interface 22d and USB port 12h.

In one embodiment, the intrinsic information stored in semiconductor memory 20c in main unit 20 contains at least information capable of identifying multimedia content. It should be understood that access to multimedia content can include links or search engines that can lead to access to various additional forms of multimedia content.

In one embodiment of the invention, one example treats main unit 20 as an industrial product. In this example, the intrinsic information for the industrial product includes two items: 1) the product line ID (PLID), and 2) the stock keeping unit ID (SKUID). The PLID is product identification information given to products by the maker during manufacturing, for example, the lot number. The PLID can include information about main unit 20, such as its manufacturing line and manufacturing date and the like. Furthermore, the SKUID is information given in distribution work for control purposes, and can include information regarding main unit 20, while also specifying the distribution route, and the like.

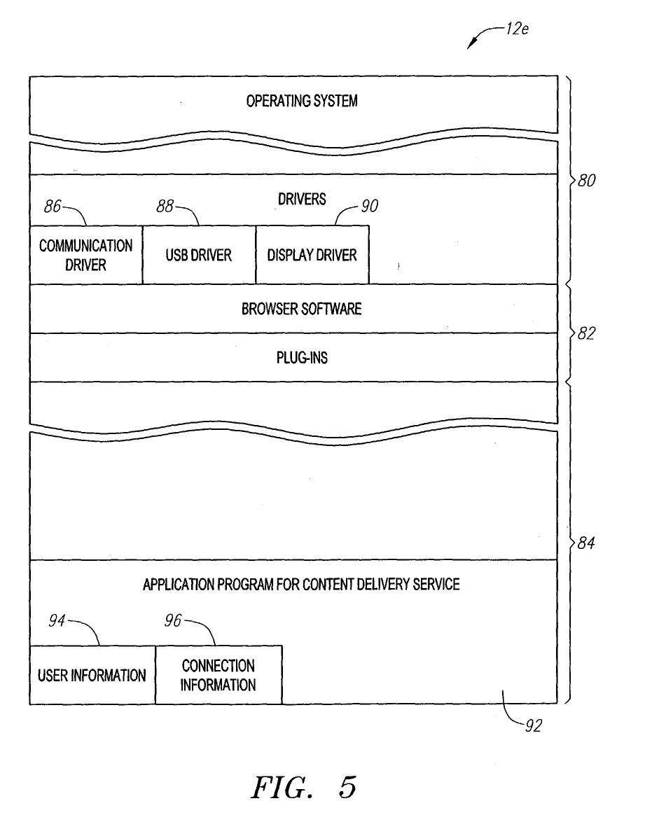

FIG. 5 is a conceptual drawing illustrating a memory map in external memory device 12e of computer 12. External memory device 12e, as previously mentioned, stores the operating system, applications and various data. Conceptually, for example, area 80 stores the operating system driver software. Area 82 stores browser software and various plug-in software. Area 84 stores user installed applications.

Driver software can include, for example, communication driver 86 for Internet connection, USB driver 88, and display driver 90. Most often these drivers are installed together with the operating system, thus, for convenience, in the diagram the drivers are included in the operating system storage area (area 80).

Browser software and plug-in software are also often installed together with the operating system. However, since, from a functional point of view, this kind of software is not within the operating system area, for convenience in the diagram, the software is placed in a separate storage area (area 82).

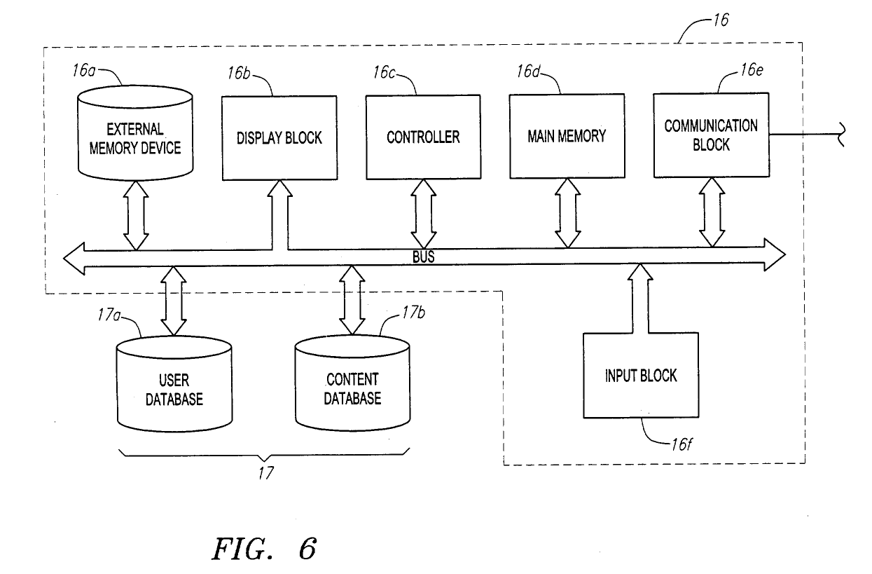

In FIG. 5, software application “Content Delivery Service Application Program” (for convenience) is stored in the application program storage area (area 84). The content delivery application program 92 can be installed from the aforementioned CD-ROM 7 or may be downloaded from the Internet. In addition to main program 92, the application program contains user information (user ID and password) for storage in user information block 94, and the URL of content delivery content provider 16 (FIG. 6) for storage in contiguous block 96.

FIG. 6 is a simplified system diagram illustrating a content-providing content provider 16 and database 17. Content provider 16 generally functions to store and provide the multimedia content. Content provider 16 can be equipped with an external memory device 16a that stores the operating system, applications and various data, a display block 16b as the user interface, a controller 16c that controls all operations of the operating system and running of applications (content selection means), a work area memory or main memory 16d for control purposes, a communications block 16e for internet connection, and an input block 16f containing a keyboard, pointing device, and the like. Further, database 17 is comprised of a user database 17a (history information storage means) that stores user information (registration information for each user and content use history information for each user), and a content database 17b that stores each type of content. Program logic stored on content provider 16, allows content provider 16 to receive a request for content. Content provider can access databases 17a and 17b and retrieve the desired content. Thereafter, content provider transmits the multimedia content back to the consumer via PC 12 and the like.

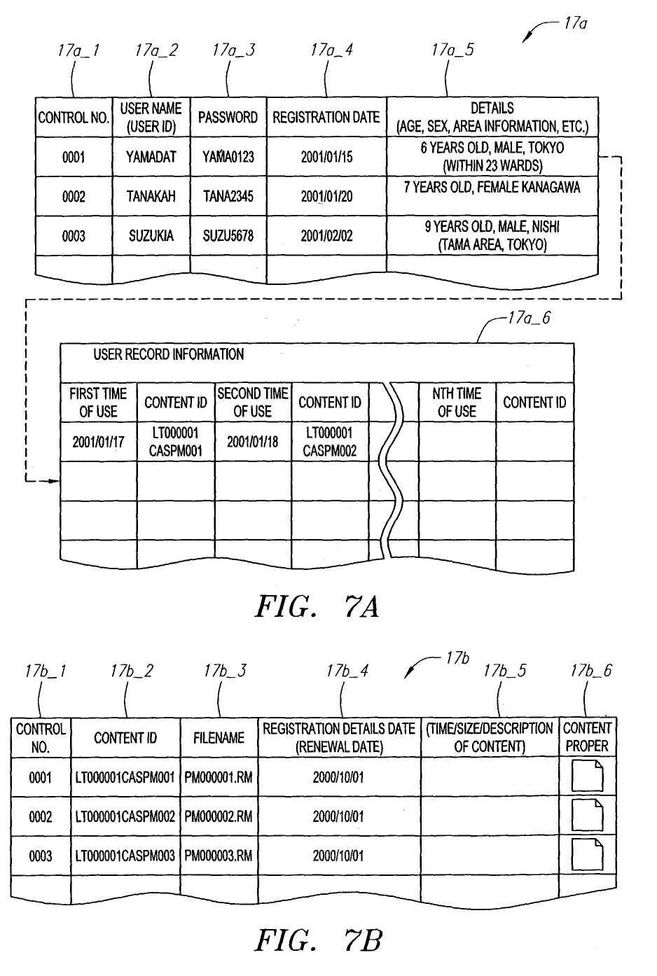

FIG. 7 is a diagram illustrating the structure of records in user database 17a and content database 17b. In the figures, one line is a data record identifiable by a unique control number, a record including a number of fields. A record in user database 17a can include a Control No. field 17a_1, user name (user ID) field 17a_2, password field 17a_3, registration date field 17a_4, details field 17a_5 and usage history information field 17a_6. A record in the content database 17b can include a control number field 17b_1, content ID field 17b_2, (content) filename field 17b_3, (content) registration date/update date field 17b_4, details field 17b_5 and content proper (format) field 17b_6.

In the example, shown in FIG. 7a, the first record in user database 17a, Control No. 001 record includes a user name “yamadat,” password “yama0123”, registration date “01/15/01,” user details, “6 years, male, Tokyo area (23 wards)”. Further, the usage history information for this particular user can include receiving content ID “LT000001 CASPM001” on “01/17/01” and content ID “LT000001 CASPM002” on “01/18/01”. From this information it is evident that the user “yamadat” (user ID) residing in Tokyo, of password “yama0123,” a male aged 6, has received certain content twice in the past.

The user can be authenticated by referencing information stored in user database 17a about when content-providing content provider 16 was last accessed with the entered user ID and password. Furthermore, processing can be conducted that prevents re-sending of content that has been provided. Processing can also be done that selects among unsent content to make an optimal selection of content close to content that has been provided.

The first record in content database 17b, Control No. 0001 record, can store filename “PM000001.rm,” content ID “LT000001 CASPM001,” registration date “10/01/2000,” and details “2 min/1.60 MB/birth zone and content type (Real Video data).” This information means the filename for content ID “LT000001 CASPM001” was “PM0000001.rm,” with a registration date “10/01/2000,” playback time of 2 minutes, file size 1.60 MB, in the birth zone. Use of content ID “LT000001 CASPM001” as the keyword allows acquisition of the content itself.

Although in this example of the embodiment, the content itself is Read Video data, this is not a limitation if a multimedia-defined file format is available. For example, Quick Time movie data can be played back/output with Quick Time streaming format. Once download completed has been detected, MPEG and AVI format files can also be played.

In the example shown in FIG. 7b, the content ID format is PLID (8 alphanumeric characters)+SKUID (8 alphanumeric characters). The first half of the ID (i.e., LT000001) is the PLID, and the latter half (CASPM001) is the SKUID. On the user side, this is a technique for directly generating content ID from intrinsic information (PLID, SKUID) of main unit 20.

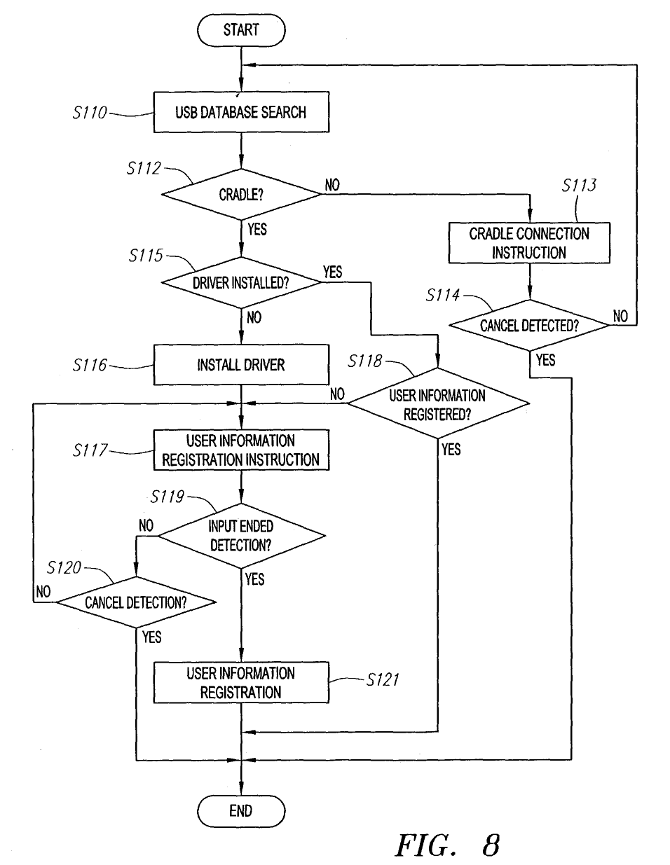

FIG. 8 is a flowchart of an initialization processing in computer 12. The flowchart illustrates operations of the content delivery service application program (hereinafter “main program 92”). Note that although operations (e.g., USB device search operations, and the like) are conducted by the operating system; in the interest of simplification, such operations can be regarded as being handled by main program 92.

At the start of the flowchart, a USB port 12h search is performed (step S110) on computer 12, and a decision is made as to whether the specific USB device (i.e., cradle 22) is coupled or not (step S112). If cradle 22 is not coupled, an instruction is given to connect (step S113), and step S110 is repeated. While the instruction is being displayed, the flowchart is ended if there is a cancel key input (step S114).

Alternatively, if cradle 22 is connected, a decision is made on whether the required driver software (e.g., USB driver 88 and each plug-in) has been installed (step S115). If the required software has not been installed, the user must install it (step S116), and the user registration instruction is displayed (step S117).

If the software has been installed, a decision is made on whether or not the user has registered (step S118). If the user is not registered, the user information registration instruction is displayed (step S117). If the user is registered, the flowchart is ended.

When the user information registration instruction is displayed, and the cancel key or user information registration end key (e.g., Enter key) input is detected (step S119, S120), the flowchart is ended on cancel key input detection. If the user information registration end key input is detected, the user information (user ID and password) is stored in the user information block 94, content provider 16 address is stored in the connection information block 96 (step S121), and the flowchart is ended.

In accordance with the flowchart, a decision is made automatically on whether the USB port of computer 12 is connected to cradle 22, and whether the required driver software has been installed (USB driver, plug-ins). If not connected, the user can be requested to connect cradle 22. If the required driver software has not been installed, the user is requested to install the software. On installing the driver software, the user is requested to enter user ID and password and a connection address. This information is stored in user information block 94 and connection information block 96. The user is ready to access the content delivery service using cradle 22 and main unit 20.

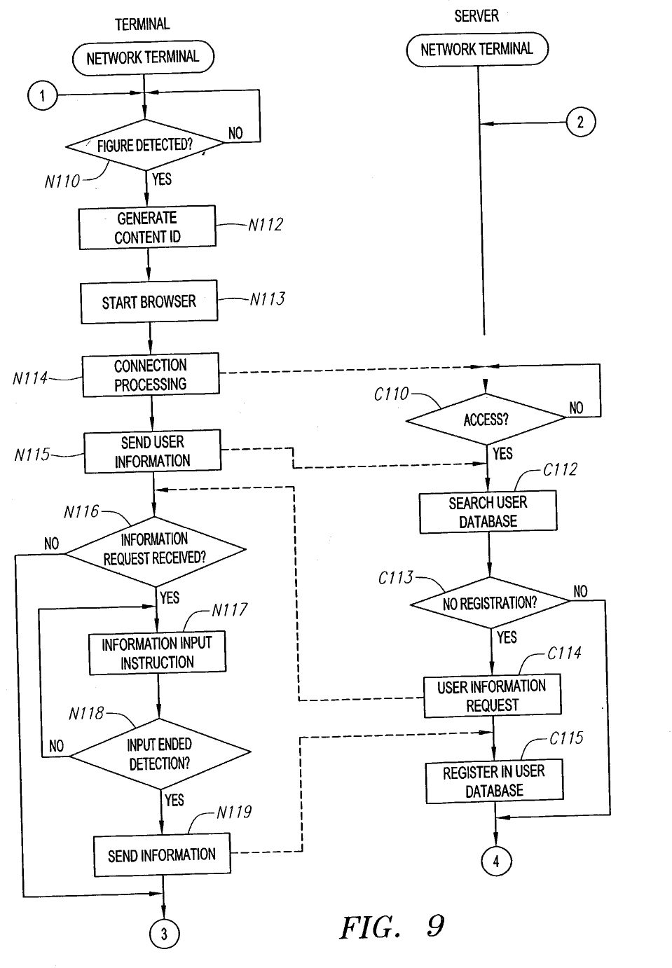

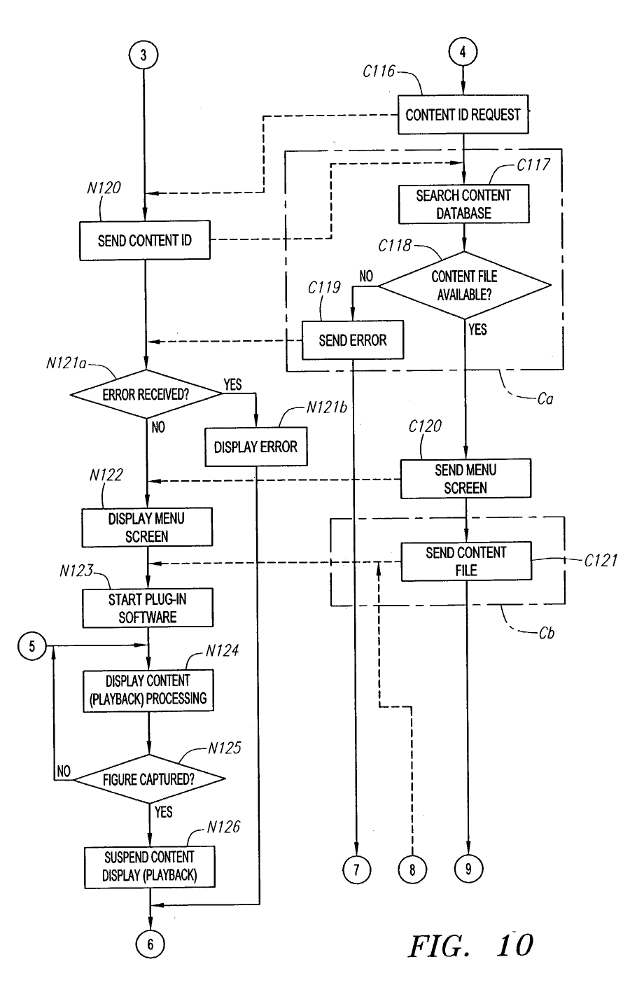

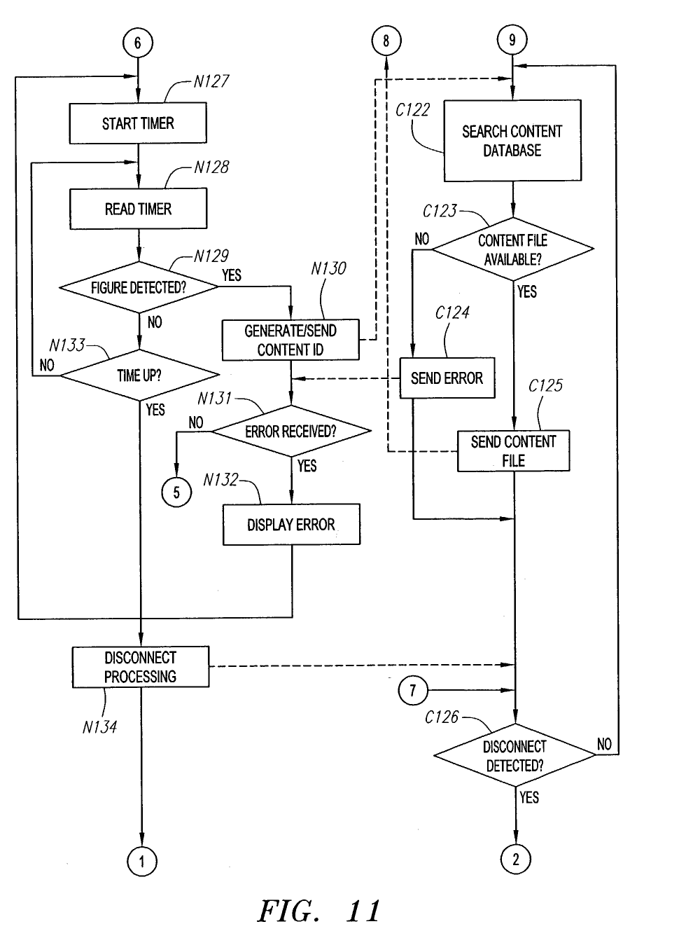

FIGS. 9-11 are flowcharts of operations for downloading and playing back content from the content delivery service. The left side of the figures indicates the flowchart of operations on computer 12, and the right side shows operations on content provider 16. The dashed lines with arrows linking the two sides of the flowcharts indicate the direction of information transfer. In the following embodiment, steps in the computer 12 flowchart begin with “N” and steps in the content-providing server begin with “C.”

On computer 12, there is a detection of whether main unit 20 is mounted on the cradle 22 (step N110); if main unit 20 is not mounted (i.e., cradle 22 alone is connected), there is a loop operation of step N110. If cradle 22 is mounted, the intrinsic information (PLID, SKUID) in the semiconductor memory 20c of main unit 20 is read. Based on the intrinsic information, a content ID is generated (step N112) for receiving content. The PLID and SKUID can be linked in a string to produce the content ID (PLID+SKUID).

The browser software is started (step N113), the connection address (URL) is read from connection information block 96, connection processing for content provider 16 is conducted (step N114), user information (user ID and password) is read from user information block 94, and that information is sent to content provider 16 (step N115).

At content provider 16, there is a detection of access from computer 12 (step S110). If access is not detected, the detection step enters a loop operation. If access is detected, user database 17a is searched (step S112) based on user information sent from computer 12. If the corresponding user information is registered in the user database 17a (step C113), the user is identified as having a legal access authority and a content ID request is sent (step S116). If the user is not registered, access is denied. Alternatively, instead of access approval/denial, user registration reception processing—i.e., sending of a user information request to computer 12—is conducted (step C114). In response to the sending of this request, user registration information returned from computer 12 is registered in user database 17a (step C115).

At computer 12, a decision is made on whether a user information request has been received (step N116). If a user information request has been received, user registration reception processing is determined instead of the above mentioned access approval/denial process, and the user information entry instruction (“Enter user ID and password”) is displayed (step N117). When entry of the user information is detected (step N118), the entered user information is sent to content provider 16 (step N119). Thereafter, content ID (generated in step N112) is sent to content provider 16 (step N120), as in the case when there is no user information request reception.

At content-providing content provider 16, content database 17b is searched according to content ID (step C117), and a decision is made on the presence/absence of the relevant record (step C118). If the relevant record is not available, an illegal content ID is determined, and an error is output (step C119). When the error is detected by computer 12 (step N121a), the terminal displays an error message (step N121b), and thereafter the process proceeds to step N127.

Alternatively, if the relevant record is available, content provider 16 sends a menu screen to computer 12 (step C120). Computer 12 displays the menu screen (step N122), and content provider 16 sends the content file (download) acquired from the relevant record to computer 12 (step C121). Computer 12 then starts plug-in software corresponding to the content type (step N123), and displays or plays back the content (step N124).

During playback or display of the same content, a decision is made on whether main unit 20 has been removed (step N125) or not. If the main unit 20 has been removed, the display or playback of the same content is suspended (step N126), and the specified timer is started (step N127). Thereafter, the timer is counted (step N130), and if detection of main unit 20 continues until time-up (step N133), the intrinsic information of main unit 20 is read, and the content ID is generated again and sent content provider 16 (step N130). On detection of error reception (step N131), an error message is displayed (step N132). If the presence of main unit 20 is not detected until time-up, disconnection processing with content-providing content provider 16 is conducted (step N134), followed by a return to step N110.

Content provider 16 searches content database 17b again based on the content ID (step C122), and checks the availability of the relevant multimedia content file (step C123). If the file exists, content provider 16 sends the file to computer 12 (step C126). If the file is not available, content-providing content provider 16 sends an error message to computer 12 (step C124). In either case, if disconnection from computer 12 is detected, there is a return to step C110, and when it is preferred to detect disconnection, there is a return to step C122.

When computer 12 detects the presence of main unit 20 in cradle 22, computer 12 reads the intrinsic information stored in the semiconductor memory 20c of main unit 20, and generates a content ID automatically based on that intrinsic information. Computer 12 also starts the browser software, and accesses the specified address (local address on CD-ROM 7 or URLs of content providers 16). Computer 12 downloads the digital experience for the content ID from content provider 16, and starts plug-in software corresponding to the content type. Computer 12 then displays the content, thereby completing one series of operations in the procedure automatically.

Accordingly, the user, by mounting main unit 20 in cradle 22, completes all user operations. Advantageously, very few keyboard operations are required of the user. The content delivery system is therefore easy to use, particularly for young children and novice personal computer users. Processing thereafter (access and content downloading) is conducted automatically by computer 12.

It is evident from the description above that to receive content delivery, it is necessary to acquire main unit 20. Therefore, a strong motivation is created for the consumer to purchase main unit 20. This can be an effective sales technique for promoting the sale of main unit 20 (or products with which main unit 20 is made available as a giveaway article) for distributors and manufacturers. Furthermore, as described above, content ID is generated based on the intrinsic information stored in main unit 20. Therefore, if a user has an interest in other content that cannot be received with the user's main unit 20, the user must acquire (purchase) another unit. Thus, this is also an effective marketing tool for promoting sales of additional units (or products with which the additional units are made available as giveaway articles).

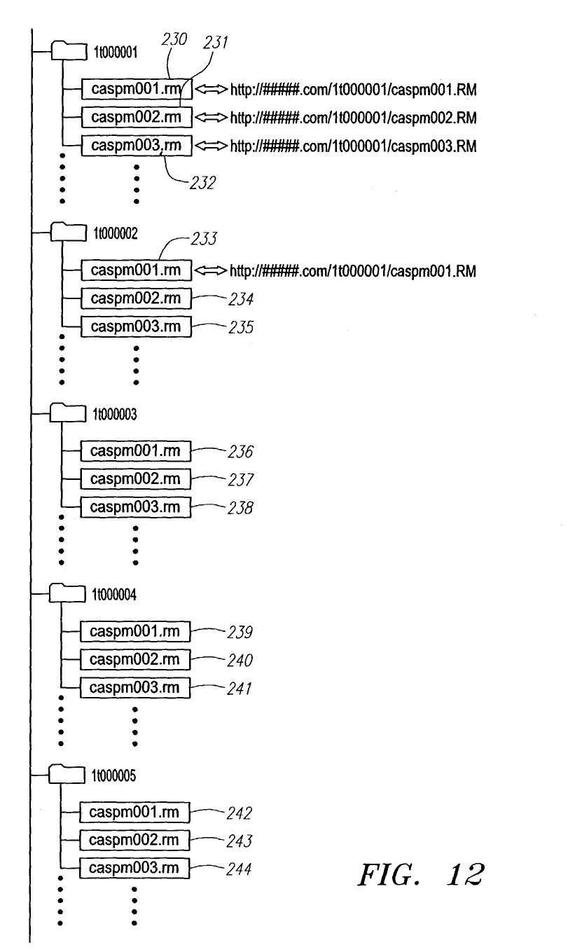

FIG. 12 is a drawing which shows the correlation between content files in the content database 17b and the intrinsic information of main unit 20. In the figure, “1t000001,” “1t000002,” “1t000003,” “1t000004,” and “1t000005” are folder names. The folders can include content files 30-44. In one example, for convenience, content files 30-44 are moving picture files with the filename extension “rm.”

In the example of FIG. 12, if the route folder (“¥”; IN UNIX SYSTEM, “/”) has the content-providing content provider 16 domain route (“http://####.com/”), then, for example, the file path of content file “caspm001.rm” is http://####.com/1t000001/caspm001.rm.

The intrinsic information of main unit 20 is a combination of the PLID and SKUID. In this example, the PLID corresponds with the “folder name”, the SKUID corresponds with the “filename”, and content ID format is taken as “domain name+PLID+SKUID+extension”. In this manner, direct access is provided to the desired content in content database 17b. For example, for a user whose main unit 20 has PLID “1T000001” and SKUID “CASPM001”, content file 230 (“caspm041.rm” in folder “1t000001”) can be provided. A user whose main unit 20 has PLID “1T000001” and SKUID “CASPM002”, can receive content file 231 (“caspm002.rm” in folder “1t000001”), and a user whose main unit 20 has PLID “1T000001” and SKUID “CASPM003” can receive content file 232 (“caspm003.rm” in folder “1t000001”). A user whose main unit 20 has the PLID “1T000002” and SKUID “CASPM001”, can receive content file 233 (“caspm001.rm” in folder “1t000002”), and a user whose main unit 20 has the PLID “1T000002” and SKUID “CASPM002” can receive content file 234 (“caspm002.rm” in folder “1t000002”).

As described in the above exemplary embodiments, since the intrinsic information of main unit 20 includes a combination of the PLID and SKUID, and the PLID corresponds with the “folder name” and SKUID corresponds with the “filename,” the invention has the advantage of making directly available content in content database 17b with a content ID format of “domain name+PLID+SKUID+extension”.

This embodiment of the present invention offers the advantage of direct access to content in content database 17b.

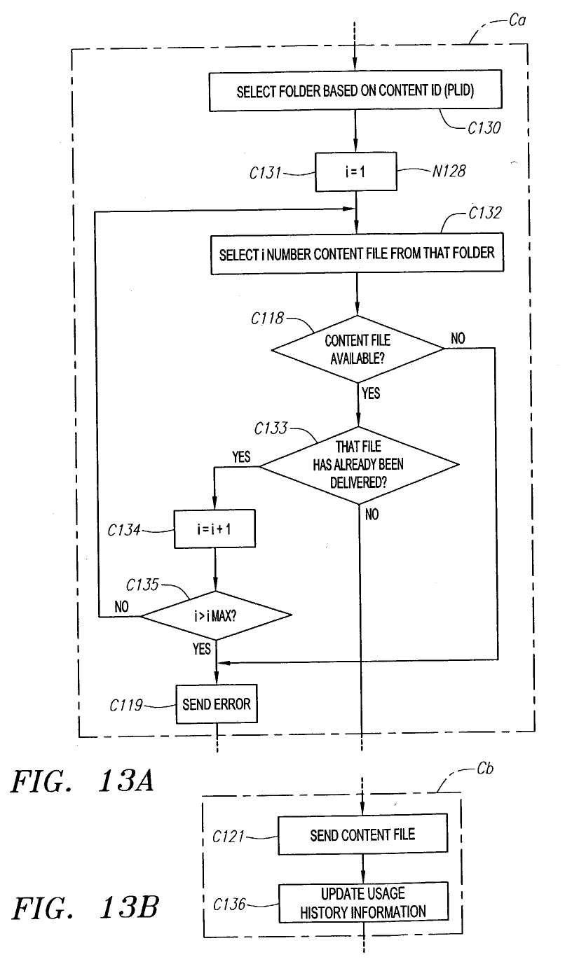

FIGS. 13a and 13b is a flowchart of another embodiment of the invention. In FIGS. 13a and 13b each flowchart corresponds with sections of main unit 20 demarcated by dashed lines Ca and Cb. Further, in FIGS. 13a and 13b, the processing steps that are the same as those in main unit 20 are given the same step number notation.

Referring to FIG. 13a, the first 8 alphanumeric characters of the content ID (i.e., the PLID) sent by computer 12 are extracted. The folder in content database 17b is selected based on the PLID (step C130). For example, if the PLID is “1T000001”, the uppermost folder in FIG. 12 is selected. Next, the loop variable i is assigned the initial value “1” (step C131), and the i ranked content file in the folder is selected (step C132). A decision is made on whether the particular content file is available (step C118), and if the content file is not available, an error message is sent (step C119).

If the content file is available, the system references the user's history information 17a_6 in the user database (i.e., the usage history for the user currently accessing the content). A decision is made on whether the content file has already been provided for the current user (step C133). If the content has not already been provided, the flowchart proceeds to step C120 in main unit 20. If the file has been provided, the systems counts up to variable i (step C134), and a decision is made on whether the maximum number of loops of variable i (imax, the number of files in the folder) has been exceeded (step C135). If imax has not been exceeded, the i-ranked content file in the folder is selected (step C132). If imax has been exceeded, and error message is sent (step C119).

In FIG. 3b, when a content file has been sent (step C121), the send date and content ID is registered in user database 17a under usage history information 17a_6 (i.e., the usage history information for the currently accessing user) (step C136).

The embodiment of FIGS. 13a and 13b offer a more flexible content delivery service based on usage history for users of main unit 20. For example, by arranging multiple content files in series in a single folder (arranged according to story, for example) the concerned user can be provided with continuous content. Also, since the improved flowchart selects a folder in content database 17b according to the PLID (intrinsic information) of main unit 20 by creating folders according to the type of main unit 20, it becomes easier to manage content delivery categories.

In each of the embodiments described above, the system is capable of providing a content delivery service using computer 12, cradle 22 and main unit 20, where main unit 20 is modeled after a popular animation character, and mounted in cradle 22. In accordance with the invention, content delivery system 10 records information in main unit 20 for the purpose of downloading content from, for example, the Internet.

In another embodiment, the above described embodiments also offer a way to access downloadable content. For example, content delivery system 10 can be applied to a mobile phone system.

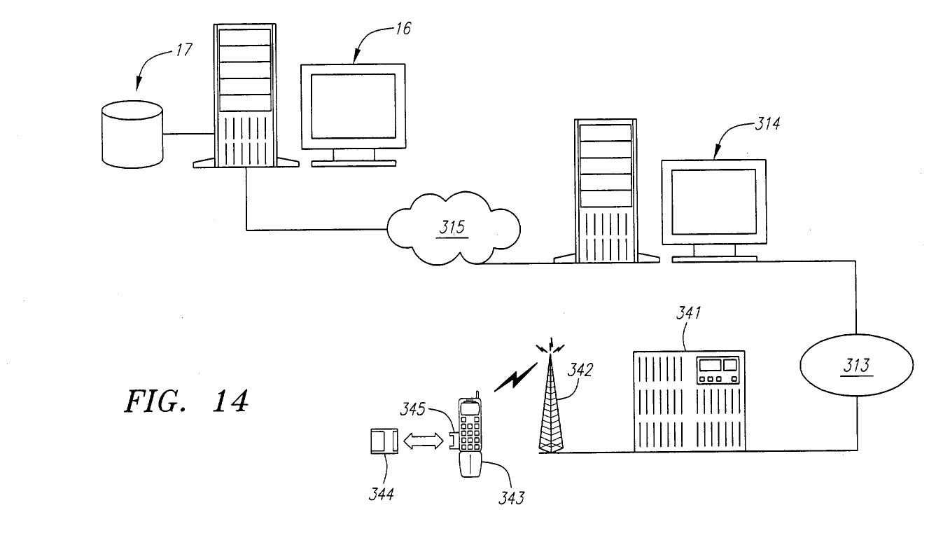

FIG. 14 illustrates an embodiment of a system configuration for content delivery system 10 that employs mobile phones. System 10 includes a database 17, content provider 16, Internet 15, the Internet service provider's access point server 314 and public telephone network 313. As shown in FIG. 14, public telephone network 313 connects to the mobile phone system via relay station 341 and wireless relay station 342.

The wireless relay 342 establishes a wireless link with the nearest mobile phone 343, and relays communications between mobile phones and between mobile phones and stationary subscriber phones. The mobile phone 343 has the necessary function of providing voice communication and also various functions required with the content delivery service of the current invention.

Naturally, mobile phone 343 is equipped with a memory slot 345 into which a card-type recording medium (external memory) 344 is inserted/removed. When the recording medium 344 is inserted in the memory slot 345, pre-recorded intrinsic information (e.g., PLID, SKUID) is read and a content ID is generated based on that intrinsic information. Content provider 16 is accessed via access point server 314, and a content file associated with the content ID is downloaded. The downloaded file is played back (or displayed) to complete the series of executed processes.

In this example, the user inserts the recording medium 344 in the memory slot 345 of the mobile phone 343. Processes thereafter (access and content downloading) are conducted automatically by the mobile phone 343. Thus, key inputs are kept to a minimum, which makes the system easier to use for children and mobile phone novices, and offers a content delivery system to which such users can quickly become accustomed.

Moreover, to receive content delivery, the recording medium 344 is acquired from an article or commodity, which the consumer has been made aware. There is therefore a motivation to purchase recording medium 344 for users who do not have one. This is an effective sales promotion technique form for distributors and manufacturers selling recording medium 344 (or products with which recording medium 344 is made available as a giveaway article). Furthermore, content ID is generated based on the intrinsic information stored in recording medium 344. Therefore, if a user has an interest in other content that cannot be received with the user's recording medium 344, the user must acquire (purchase) recording medium (memory card). This is also an effective technique in promoting sales of the recording medium 344 (or products with which recording medium 344 are made available as giveaway articles).

While particular embodiments of the present invention have been shown and described, it will be obvious to those having ordinary skill in the art that changes and modifications can be made without departing from this invention in its broader aspects. Therefore, the appended claims are to encompass within their scope all such changes and modifications as fall within the scope of this invention.

What is claimed is:

1. A content delivery system comprising:
means defining a product or an optional distributable article that is an auxiliary of said product, connected directly or by means of a relay to a terminal, for recording information for the purpose of specifying content, said terminal being capable of downloading said content based on said information, and displaying or playing back said content.

2. A content delivery system comprising:
a content-providing server that delivers content via the Internet when said content-providing server is accessed;
a terminal for downloading requested content from said content-providing server, and for storing information for the purpose of specifying content; and
a coupling means for coupling said terminal and said article, said terminal, when connected to said article capable of accessing the content-providing server based on information stored in said article, the associated content being downloaded and displayed or played back by the system's playback/display means.

3. The content delivery system of claim 2, wherein said content-providing server comprises a history information storage means capable of maintaining a record of content provided to said terminal; and
a content selection means that references history information stored in said history information storage means and selects content to be provided for said terminal when access to said content-providing server by said terminal is detected.

4. An apparatus for accessing content via an open network from a content delivery source comprising:
a memory device for recording and storing intrinsic information;
a detection device for detecting interconnection between said memory device and said output terminal;
a reading device for reading intrinsic information stored in said memory device;
a specific information generating device that generates specific information specifying said content from intrinsic information read by said reading device;
a reception device that receives content associated with specific information generated by said specific information generating device on access of said delivery source in response to detection of the interconnection by said detection device; and
a playback/output device for displaying or playing output received content from said reception device.

5. The apparatus of claim 4, wherein said intrinsic information comprises information associated with the manufacture or distribution of said memory device.

6. A method for accessing content via an open network from a content delivery source, said method comprising:
detecting a memory device;
reading intrinsic information stored in said memory device to generate specific information which specifies content from said intrinsic information; and
receiving content corresponding to said specific information when said delivery source is accessed.

7. The method of claim 6, further comprising delivering intrinsic information to said memory device to be stored in said memory.

8. A recording medium that includes a program logic executable by an output terminal that receives content on access of a delivery source via an open information network, said program logic when executed causes said terminal to:
detect a memory read;
read intrinsic information stored in said memory;
generate specific information that specifies said content from said intrinsic information;
receive content corresponding to said specific information when said delivery source is accessed; and
output said content.

9. An apparatus for accessing a digital experience comprising:
a main unit including a memory device;
an input device operable to read intrinsic information stored on said memory device; and
a host device operably coupled to said input device to receive said intrinsic information and provide preselected multimedia content in response.

10. The apparatus of claim 9, wherein said main unit is acquired by chance or intent.

11. The apparatus of claim 9, wherein said memory device is taken from the group consisting of a PROM, EPROM, EEPROM, DRAM, SRAM, ROM and RAM.

12. The apparatus of claim 9, wherein said input device comprises a receptacle for receiving an edge card connector coupled to said memory device.

13. The apparatus of claim 9, wherein said input device provides information to said memory device, wherein said memory device is operable to store said data.

14. The apparatus of claim 9, wherein said input device comprises feedback controls for controlling said multimedia content.

15. The apparatus of claim 9, wherein said host device is a personal computer including a keyboard, a mouse, and a monitor, said preselected multimedia content being displayed on said monitor.

16. The apparatus of claim 9, further comprising a content provider operably coupled to said host device for delivering said multimedia content to said host device in response to said intrinsic information.

17. The apparatus of claim 9, wherein said input device comprises a support for said main unit including a microcontroller for detecting when said main unit is engaged with said input device.

18. A system for accessing multimedia content comprising:
an input device configured to receive a first access key including a memory device;
a host processor operably coupled to said input device and configured to receive intrinsic information stored on said memory device; and
a content source operable to provide said multimedia content to said host processor.

19. The system of claim 18, wherein said input device is configured to receive a second access key including a memory device.

20. The system of claim 18, wherein said content source comprises a CD-ROM.

21. The system of claim 18, wherein said content source comprises a processor accessible over the Internet.

22. The system of claim 18, wherein said host processor is a personal computer including a monitor for displaying said multimedia content.
